(19) United States
(12) Patent Application Publication
(10) Pub. No.: US 2008/0305255 A1
(43) Pub. Date: Dec. 11, 2008

(54) OPTICAL WAVEGUIDE COATING

(75) Inventors: Ekaterini Bogas Beauvais, Fountain Inn, SC (US); Kelly S. Vose, Greenwood, SC (US)

Correspondence Address: THOMPSON HINE L.L.P.;Intellectual Property Group, P.O. BOX 8801, DAYTON, OH, 45401-8801, US

(73) Assignee: FUJIFILM MANUFACTURING U.S.A. INC., Greenwood, SC (US)

(21) Appl. No.: 11/759,517

(22) Filed: Jun. 7, 2007

(51) Int. Cl. G02B 6/10

(52) U.S. Cl. 427/163.2

(57) ABSTRACT

A method of making a waveguide is disclosed. The method comprises providing an optical core having a first surface and a second surface, applying a cladding material to the first and the second surface of the optical core to form a first cladding layer on the first surface of the optical core and a second cladding layer on the second surface of the optical core, and applying a light absorbing composition including a light absorbing material and a first adhesive polymer on at least one of the first cladding layer and the second cladding layer to form a light absorbing layer. The first adhesive polymer is selected from the group consisting of urethane, epoxy, polyester, acrylic adhesives and mixtures thereof.

### BACKGROUND

The present application relates generally to optical waveguides.

Optical waveguides have been used to develop panels that may be useful as optical display screens. The panel may be used for rear projection displays, such as those taught in U.S. Pat. No. 6,457,834 and U.S. Pat. No. 6,999,665, which are incorporated by reference herein. The panel may be used for front projection displays, such as those taught in U.S. Pat. No. 6,535,674, U.S. Pat. No. 6,741,779, and U.S. Pat. No. 7,116,873, which are incorporated by reference herein. Waveguides include a transmissive core bound by cladding where the index of refraction of the cladding is less than the index of refraction for the core. Typically, waveguides may be in the form of flat ribbons stacked vertically and extending continuously in the horizontal direction along the entire panel width. The waveguides are adhered or bound together. The stacked waveguides may be adhered with an adhesive between the waveguides to hold the panel together.

A desirable panel made from waveguides has good contrast, high brightness, a good viewing angle, good color reproduction, high percent transmission, good stability, and high mechanical strength. It is difficult to construct a panel that maximizes all these properties.

### SUMMARY

In one aspect the present invention is a method for making a waveguide. The method comprises providing an optical core having a first surface and a second surface, applying a cladding material to the first and the second surface of the optical core to form a first cladding layer on the first surface of the optical core and a second cladding layer on the second surface of the optical core, and applying a light absorbing composition including a light absorbing material and a first adhesive polymer on at least one of the first cladding layer and the second cladding layer to form a light absorbing layer. The first adhesive polymer is selected from the group consisting of urethane, epoxy, polyester, acrylic adhesives and mixtures thereof.

Another aspect of the present invention is a method for making a waveguide that comprises providing an optical core having a first surface and a second surface, applying a cladding material including a first adhesive polymer to the first and the second surface of the optical core to form a first cladding layer on the first surface of the optical core and a second cladding layer on the second surface of the optical core, and applying a light absorbing composition including a light absorbing material and a second adhesive polymer to at least one of the first cladding layer and the second cladding layer to form a light absorbing layer. The first adhesive polymer and the second adhesive polymer are selected from the group consisting of a urethane, epoxy, polyester, acrylic adhesives and mixtures thereof.

Other aspects of the disclosed waveguides and associated methods will become apparent from the following description, the accompanying drawings and the appended claims.

### BRIEF DESCRIPTION OF THE DRAWINGS

FIGS. 1-3 are side elevational views, in section, of various embodiment of a waveguide;

FIG. 4 is a side elevational view of a panel made from a plurality of stacked waveguides like those in FIGS. 1-3;

FIGS. 5-7 are side elevational views, in section, of various embodiments of waveguides including an adhesive layer;

FIG. 8 is a side elevational view of a panel formed from a plurality of stacked waveguides like those in FIGS. 5-7; and

FIG. 9 is a side elevational view, in section, of a waveguide showing the angle of acceptance.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical projection system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

As used herein the term “waveguide” means a device for guiding the flow of electromagnetic waves along a desired path. Waveguides include a core material bounded by a cladding wherein the index of refraction of the cladding is less than the index of refraction of the core. The waveguide may further include a light absorbing layer and/or an adhesive to adhere a plurality of waveguides together. Within a waveguide the core material has a refractive index that is higher than the refractive index of the cladding.

As used herein the term “panel” means a plurality of waveguides stacked and adhered to one another. The panel may be used for viewing images. The panel may be part of a screen used in visual projection applications. The panel may be useful in rear projection displays, such as those taught in U.S. Pat. No. 6,457,834 and U.S. Pat. No. 6,999,665. The panel may be useful in front projection displays, such as those taught in U.S. Pat. No. 6,535,674, U.S. Pat. No. 6,741,779, and U.S. Pat. No. 7,116,873.

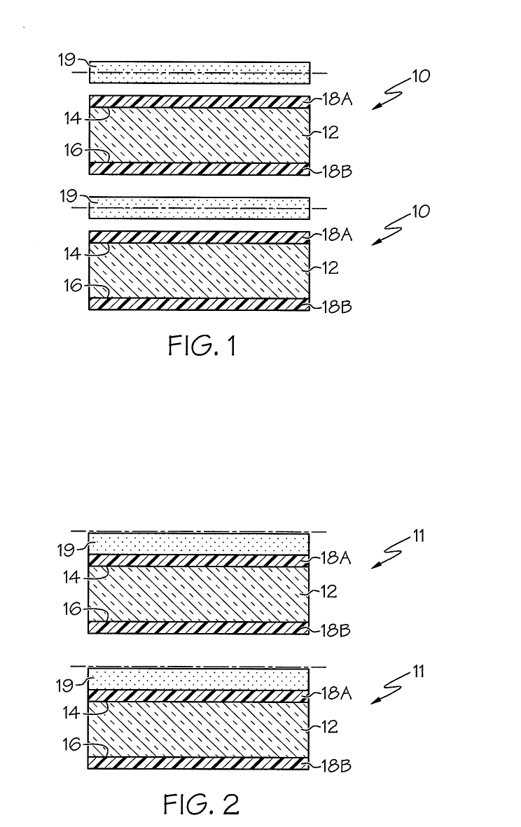

The various compositions or materials within each of the layers of the various waveguides in the Figures described below will be described in further detail under the headings: The Core, The Cladding, The Light Absorbing Composition, and The Adhesive Layer. FIG. 1 shows one embodiment of waveguides, generally designated 10. Waveguides 10 includes an optical core 12 having a first surface 14 and a second surface 16, a first cladding layer 18A applied to the first surface 14, and a second cladding layer 18B applied to the second surface 16 of core 12. The core may be provided or prepared and may be a sheet of material with the desired refractive index for the chosen panel parameters. One important parameter is the acceptance angle desired for light entering the panel. The core may have a thickness of 10 mil, 20 mil, or any other thickness that will work in the manufacturing process and result in a panel with the desired acceptance angle and other screen characteristics. In one embodiment, the cladding layer may be about 1 μm to 11 μm thick. A plurality of waveguides 10 may be adhered together by positioning a light absorbing composition 19 including a first adhesive between stacked waveguides 10. In another embodiment as shown in FIG. 2, the light absorbing composition may be applied to the first cladding layer 18A. In another embodiment, light absorbing layer 19 including the first adhesive may instead be applied to the second cladding layer 18B. A plurality of waveguides 11 may be adhered together by stacking the plurality of waveguides 11 so that the light absorbing composition 19 including a first adhesive is applied to the exposed cladding layer of the adjacent waveguide in the stack.

FIG. 3 shows another embodiment for waveguides, generally designated 13. Waveguides 13 includes an optical core 12 having a first surface 14 and a second surface 16, a first cladding layer 18A applied to the first surface 14 of core 12, a second cladding layer 18B applied to the second surface 16 of core 12, a first light absorbing composition 19A applied to the first cladding layer 18A, and a second light absorbing layer 19B applied to the second cladding layer 18B. The light absorbing composition 19A, 19B includes a light absorbing material and a first adhesive. Light absorbing composition 19A, 19B are shown of equal thickness on cladding layers 18A, 18B. In another embodiment, light absorbing composition 19A, 19B may be of different thicknesses. In one embodiment, the light absorbing composition once formed into a light absorbing layer may be about 1 μm to 11 μm thick. The thickness of the light absorbing layer can be adjusted so that it does not interfere with the projected image. A plurality of waveguides 13 may be adhered together by stacking the plurality of waveguides 13 so that the light absorbing composition 19A and 19B of adjacent waveguides within the stack are touching.

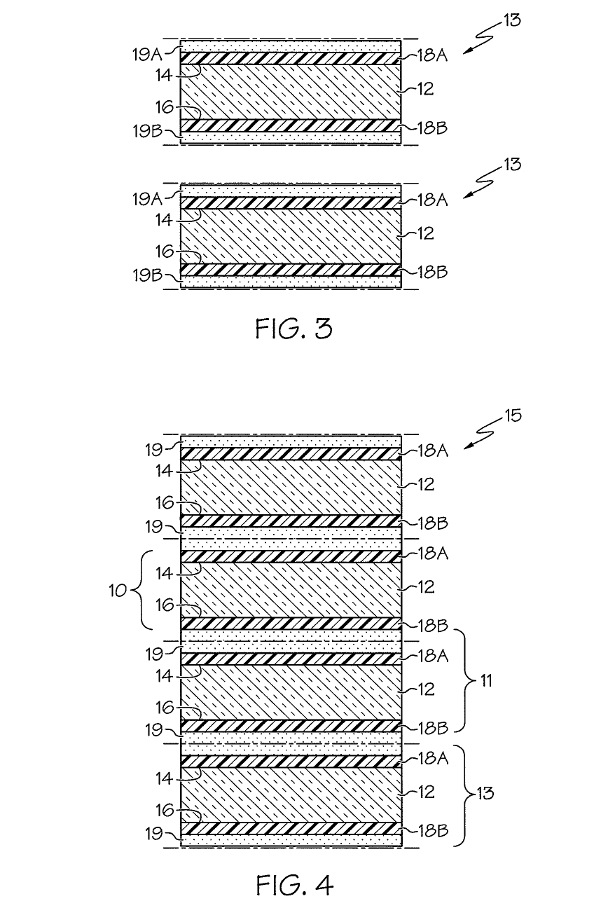

As shown in FIG. 4, one embodiment of a panel, generally designated 15, may be formed from a plurality of stackable waveguides, such as waveguides 10, 11, and/or 13 for example, or other waveguides, such that the light absorbing composition 19 bonds or adheres consecutive waveguides together. Panel 15 includes a plurality of each of the following layers: a light absorbing layer 19, a first cladding layer 18A, a core 12, and a second cladding layer 18B. Those skilled in the art will appreciate that a typical panel is not limited to the portion shown in FIG. 4, but may include whatever number of stacked waveguides is necessary to achieve a panel of the desired dimensions. The panel may have thousands of stacked waveguides.

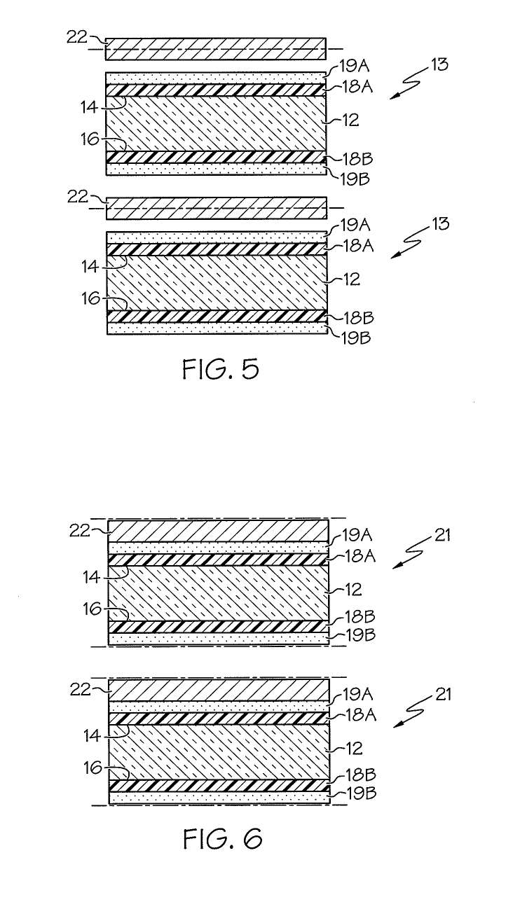

As shown in FIG. 5, a plurality of waveguides 13 from FIG. 3 may be adhered together by positioning an adhesive composition 22 between stacked waveguides 13. Adhesive composition 22 may include the same or different adhesive or adhesive mixture as the light absorbing composition 19A, 19B. In one embodiment, the waveguides have a total thickness (i.e., the combined thickness of the cladding, the light absorbing layers, and adhesive layers on both sides of an individual core layer and the core) of about 110 μm to about 1200 μm. Within the total thickness the core may be between about 100 μm to about 1100 μm.

FIG. 6 shows another embodiment of a waveguide, generally designated 21. Waveguide 21 includes an optical core 12 having a first surface 14 and a second surface 16, a first cladding layer 18A applied to the first surface 14 of core 12, a second cladding layer 18B applied to the second surface 16 of core 12, a first light absorbing composition 19A including a first adhesive applied to the first cladding layer 18A, a second light absorbing layer 19B applied to the second cladding layer 18B, and an adhesive composition 22 applied to the first light absorbing composition 19A. In another embodiment, adhesive composition 22 may be applied to the second light absorbing composition 19B. A plurality of waveguides 21 may be adhered together by stacking the plurality of waveguides 21 so that the adhesive composition 22 may be applied to the exposed cladding layer of the next waveguide 21 in the stack. In another embodiment, as shown in FIG. 7, the adhesive composition 22 may be applied to each of the first and the second light absorbing composition 19A, 19B. This waveguide embodiment is generally designated 23. A plurality of waveguides 23 may be adhered together by stacking the plurality of waveguides 23 so that the adhesive composition 22 on consecutive waveguides within the stack of waveguides are touching. Again, the adhesive layer 22 is shown of equal thickness on each cladding layer of both waveguides. In another embodiment, the thickness of the adhesive layer 22 may be different.

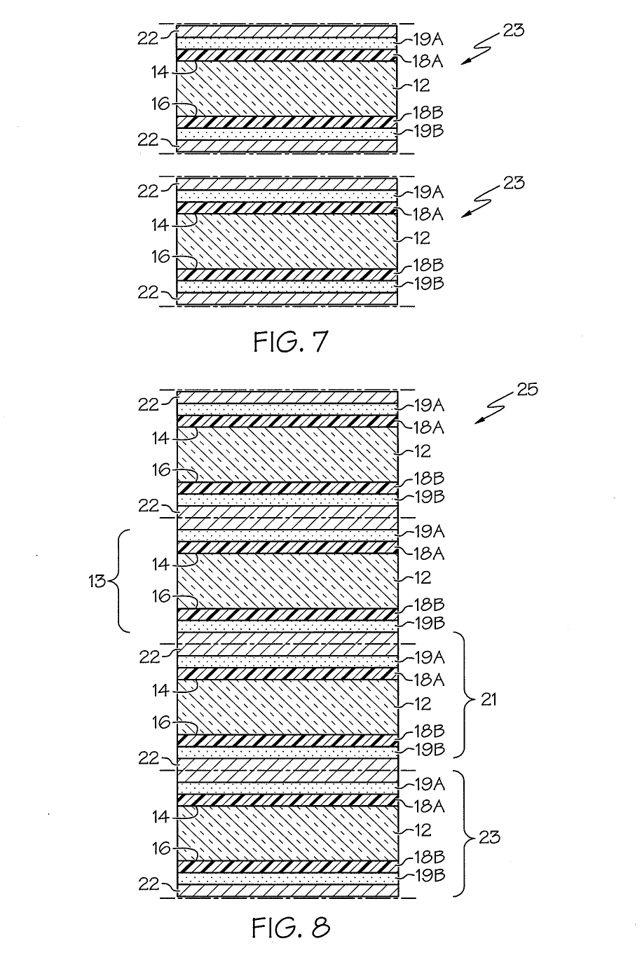

For each embodiment of the waveguides shown in FIGS. 1-3 and 5-7, a plurality of waveguides may be stacked and adhered together to form a panel of any desirable size. One embodiment of a panel, generally designated 25 as shown in FIG. 8, may be formed by stacking a plurality of waveguides 13, 21, and/or 23. Panel 25 includes a plurality of each of the following layers: an adhesive layer 22, a first light absorbing composition 19A, a first cladding layer 18A, a core 12, a second cladding layer 18B, and a second light absorbing composition 19B. Those skilled in the art will appreciate that a typical panel is not limited to the construction shown, but may include many more layers stacked and adhered together as discussed above.

Optionally, panels of stacked waveguides, like panels 15 and 25, may include a light directing film that is used to direct light rays arriving in a shallow entrance angle into core 12. The panel may include a light shaping film on the viewing side of the panel or screen, separately or in combination with the light directing film, to spread light in a horizontal and vertical direction as the light exits the panel to thereby increase the viewing angles. The panel may include any other features to improve the transmission of light rays along the length of the waveguides.

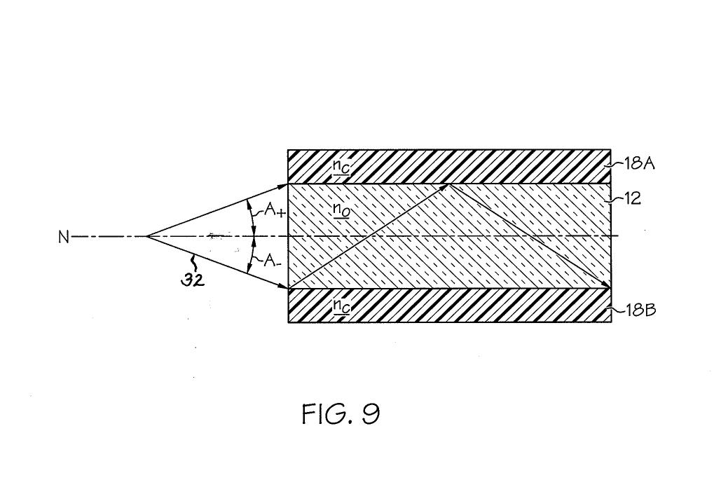

In simple terms, the behavior of light entering the core material in a waveguide is fundamentally controlled by the property of the core, cladding, and medium surrounding the waveguide. Referring to FIG. 9, the core has a refractive index no and the cladding has a refractive index n_{c}. A light ray entering core 12 is either refracted into the cladding 18A, 18B and attenuated (absorbed), or it is totally internally reflected at the core/cladding boundary. Total internal reflection is the reflection of the total amount of incident light at the boundary between the core and cladding. In this manner light travels within core 12 along the length of the waveguide. The maximum angle at which the light ray may enter core 12 and travel by total internal reflection within the core is termed the acceptance angle A. The value of the acceptance angle depends mainly on the properties of the selected core and cladding. The acceptance angle A, half the angle of the light acceptance cone 32, is measured between the incident ray and the normal line N to the interface of core 12, as shown in FIG. 9. The acceptance angle is often labeled theta θ. The angle range for the acceptance angle is understood by the relationship sin θ≦(nₒ^{2 l -n}_{c}²)^{1/2} (assuming incoming ray is traveling through air with a refractive index of 1). When the acceptance angle is above the normal line N it is considered to be a positive acceptance angle A₊ and when the acceptance angle is below the normal line N it is considered to be a negative acceptance angle A₋. The larger the difference in refractive index between core 12 and the cladding 18A, 18B, the larger the acceptance angle may be for light rays entering core 12 to be totally internally reflected.

The first and second cladding layers 18A, 18B may have the same refractive index. The refractive index of cladding layers 18A, 18B is less than the refractive index of core 12. The refractive index of a material is the ratio of the velocity of propagation of an electromagnetic wave in vacuum to its velocity in the material. The refractive index (n) of a material is defined as follows:

n=Vᵥ/V

wherein Vᵥ is the velocity of light in a vacuum and V is the velocity of light in the material. In general light slows down when it enters a material. Therefore, the refractive index of a material will always be greater than 1. Most materials have refractive indices between 1.32 and 2.40.

Some typical refractive indexes (RI) of various materials are about:

TABLE 1

| MATERIAL | RI |
|---|---|
| Chlorotrifluoro-Ethylene (CTFE) | 1.42 |
| Cellulose Propionate | 1.46 |
| Cellulose Acetate Butyrate | 1.46-1.49 |
| Cellulose Acetate | 1.46-1.50 |
| Methylpentene Polymer | 1.485 |
| Ethyl Cellulose | 1.47 |
| Acetal Homopolymer | 1.48 |
| Acrylics | 1.49 |
| Cellulose Nitrate | 1.49-1.51 |
| Polypropylene (Unmodified) | 1.49 |
| Polyallomer | 1.492 |
| Polybutylene | 1.50 |
| Ionomers | 1.51 |
| Polyethylene (Low Density) | 1.51 |
| Nylons (PA) Type II | 1.52 |
| Acrylics Multipolymer | 1.52 |
| Polyethylene (Medium Density) | 1.52 |
| Styrene Butadiene Thermoplastic | 1.52-1.55 |
| PVC (Rigid) | 1.52-1.55 |
| Nylons (Polyamide) Type 6/6 | 1.53 |
| Urea Formaldehyde | 1.54-1.58 |
| Polyethylene (High Density) | 1.54 |
| Styrene Acrylonitrile Copolymer | 1.56-1.57 |
| Polystyrene | 1.57-1.60 |
| Polycarbomate (Unfilled) | 1.586 |
| Polystyrene | 1.59 |

As can be noted from this information many polymers that might be used in waveguides have refractive indexes that are fairly close together.

### The Optical Core

The optical core may be any optical grade material deemed suitable for optical waveguides. For example, the optical core may include one or more of the following: polycarbonates, polymethylmethacrylate (PMMA), glass, polyesters, cellulose, cyclic olefins and/or copolymers thereof, or other suitable optical grade materials. The optical core may be one of the materials listed in Table 1 above or combinations thereof. Examples of the polyester cores include polyethylene terephthalate, polyethylene naphthalate or a combination thereof. Cores are selected that have excellent optical properties and will transmit light with minimal distortion or absorption of light. To provide good viewing characteristics, the optical core may have a percent transmission of between about 80 to about 100%. Transmissions less than 80% may absorb or scatter more light, thereby reducing the overall brightness of the resulting waveguide.

In one embodiment the selected optical core may have a refractive index between about 1.4 to about 1.6. A polycarbonate core may have a refractive index of about 1.58. A PMMA core may have a refractive index of about 1.48. A cellulose core may have a refractive index of about 1.54. A polyethylene terephthalate core may have a refractive index of about 1.57.

At this point, those skilled in the art will appreciate that any known or available optical material or combinations of optical materials may be used to form the core without departing from the scope of the present disclosure.

### The Cladding

The cladding layers of the various waveguide embodiments disclosed herein include a cladding material. The cladding material may be any polymer, polymer mixture, organic material, inorganic material, or mixtures or combinations thereof that has an index of refraction that is lower than the index of refraction of the optical core and will result in a waveguide with the desired acceptance angle range. In one embodiment, the waveguide may have an acceptance angle of ±5 to ±40°. In another embodiment, the waveguide may be designed to have an acceptance angle of ±5 to ±30°.

Representative examples of the cladding material include a styrene butadiene, a styrene polymer or copolymer, polyester, a polyvinyl pyrrolidone, an acrylic polymer or copolymer, a polyethylene oxide, a polyvinylalcohol, an epoxy resin, an acrylate, an acrylate ester, or combinations thereof.

Below are examples of various cladding material, however, the cladding material is not to be construed as limited thereto. In one embodiment, the butadiene may be a styrene butadiene, a carboxylated styrene butadiene or combinations thereof available from Dow Reichhold Specialty Latex or Mallard Creek Polymers. In another embodiment, the polyester may be an anionic liquid polyester available from EvCo Research LLC. Polyvinyl pyrrolidone may be available from BASF. Acrylic may include polymers or copolymers of acrylic acids and methacrylic acids or derivatives thereof such as amides or esters. In one embodiment, the acrylic polymer, copolymer, or latex may be a styrene acrylic, vinyl acrylic, or carboxylated acrylic or mixtures thereof. The acrylic polymer, copolymer, or latex may be available from Ciba Specialty Chemicals, Dow Reichhold Specialty Latex, Para-Chem, or Specialty Polymers, Inc. Polyethylene oxide may be available from The Dow Chemical Company. Polyvinyl alcohol may be available from Dupont. The epoxy resin may be a dispersion that may be available from Chemtrec or an epoxy modified alkyl resin from Surface Specialties. The acrylate may be n-butylacrylate latex, polyethylene glycol diacrylate, carboxylated styrene acrylate, or other acrylates available from Sartomer Company or Dow Reichhold Specialty Latex. Acrylate esters may be available from Sartomer Company.

In one embodiment, the core selected is a polycarbonate core, and the cladding material selected for use with the polycarbonate core is a polystyrene butadiene available from Mallard Creek Polymers. In another embodiment, the core selected is a PMMA, and the cladding material selected for use with the PMMA is a vinyl acrylic or a carboxylated acrylic copolymer or mixtures thereof, available from Ciba Specialty Chemicals. In one embodiment the cladding material is a mixture of carboxylated acrylic copolymers, Glascol® RP4 and Glascol® RP3 microemulsions that may be crosslinked by their carboxylic functionality. The RP3 and RP4 may be mixed as about 25% RP3 with about 75% RP4 to about 75% RP3 to about 25% RP4.

The cladding may include a surfactant. The surfactant is usually added to the composition to aid in the application of the cladding composition onto the core. The surfactant helps the cladding composition flow smoothly during manufacturing. The cladding composition may also include water. The resulting cladding composition may be a mixture of liquids to form a solution that may be mixed and used in the manufacturing process.

Examples of surfactants include anionic surfactants, amphoteric surfactants, cationic surfactants, and non-ionic surfactants. Examples of anionic surfactants include alkylsulfocarboxylates, alpha olefin sulfonates, polyoxyethylene alkyl ether acetates, N-acylaminoacids and salts thereof, N-acylmethyltaurine salts, alkylsulphates, polyoxyalkylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates and the like. Examples of the cationic surfactants include 2-vinylpyridine derivatives and poly-4-vinylpyridine derivatives. Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

Examples of non-ionic surfactants include non-ionic fluorinated surfactants and non-ionic hydrocarbon surfactants. Examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are typically added to the coating in an amount ranging from about 0.1 to 1000 mg/m², preferably from about 0.5 to 100 mg/m².

The cladding may optionally further comprise one or more conventional additives, such as biocides; pH controllers, matting agents, preservatives; defoamers; viscosity modifiers; dispersing agents; UV absorbing agents; anti-oxidants; and/or antistatic agents. These additives may be selected from known compounds and materials in accordance with the objects to be achieved. In one embodiment, the above-mentioned additives may be added in a range of 0 to 10% by weight, based on the solid content of layer.

The coatings may be formed by any method known in the art. Examples of coating methods include curtain coating, extrusion coating, air-knife coating, slide coating, forward roll coating, reverse roll coating dip coating, and rod bar coating. In another embodiment, the coatings may be laminated onto the core, or applied to the core by film transfer.

In applying the cladding composition as a coating on the core the cladding may be applied to one side of the core and then dried. Once the cladding composition has dried into a cladding layer, the process may be repeated to apply the cladding composition to the other side of the core or to apply other layers on the now dried cladding layer. The second layer is then allowed to dry (in an oven, at climate controlled conditions, at room conditions or by any other method known in the art.) In another embodiment multiple layers may be applied to the core simultaneously and then dried, left to set, or cured by any method known in the art. In another embodiment, the cladding is coated onto both sides of the core simultaneously and then dried.

In another embodiment, the cladding layer including the cladding material further includes an adhesive polymer. The adhesive polymer may be any adhesive that will result in a waveguide of the selected thickness with high mechanical strength that is still flexible for improved durability. The adhesive should be one that will not react with or degrade the optical core. The amount and selection of the adhesive may also depend on how the adhesive effects the refractive index of the cladding layer in relation to the selected acceptance angle for the waveguide. Adhesives useful within the cladding should provide good adhesion of the cladding layer to the core. In one embodiment, the adhesive polymer becomes sticky (is adhesive) at about 50° to about 95° C.

The adhesive may be a rubber, a urethane, a cellulose derivative, a polyester, a polyacrylate, an epoxy, a silicone, a formaldehyde resin, a phenolic resin, a vinyl polymer, a polyether, a furane, a polyaromatic, or mixtures thereof. In one embodiment, the adhesive may be a dispersion. The dispersion may be aqueous or in other solvent. In one embodiment, the adhesive may be a hot melt. In another embodiment, the adhesive is about 30% solid to about 100% solid of the cladding composition. Unless otherwise indicated, all percentages, ratios and coat weights set forth herein are by weight based on solids.

Examples of rubber based adhesives include natural rubber, derivatives of natural rubber, synthetic rubber, or derivatives of synthetic rubber. The derivatives of synthetic rubber include butyl, polyisobutylene, styrene butadiene, acrylonitrile butadienes, neoprene, and chloroprene derivatives. Examples of urethane based adhesive include polyurethanes, polycarboxylated polyurethanes, polycarbonated polyurethanes, polyether polyurethanes, and polyurethane polyesters. In one embodiment, the urethane based adhesives may be aromatic or aliphatic. Various urethanes may be available from CL Hauthaway & Sons Corporation or Noveon, Inc. Examples of cellulose derivative based adhesives include cellulose acetate, ethyl cellulose, and carboxy methyl cellulose. The polyester based adhesive may be saturated or unsaturated and examples thereof include polystyrene and polyamides. Examples of polyacrylate based adhesives include methacrylates, cyanoacrylates, and acrylamides. Examples of vinyl polymer based adhesives include polyvinyl acetate, polyvinyl acetal, and polyvinyl chloride.

In one embodiment the adhesive may be an aliphatic or aromatic polyurethane polyester adhesive. Such adhesives may be an aqueous dispersion available from Cytec Industries under the trade name Cydrothane, Alfa Adhesives under the trade name Simalfa, Helmitin Inc. under the trade name Helmibond, and Bayer MaterialScience LLC under the trade name Dispercoll.

In another embodiment, the cladding material may further include polyethylene oxide to aide in the separation of layers in a simultaneous coating process where multiple layers are applied to the core at the same time. In one embodiment, the polyethylene oxide is 7% solids polyethylene oxide. The polyethylene oxide may be about 40 to about 60% solid in combination with the cladding material. In one embodiment, the cladding material may be an acrylic based polymer.

In one embodiment, any of the polymers included in the cladding may be cross-linked in order to impart mechanical strength, increase service temperature and moisture resistance to the layer. This can be done using any cross-linking agent known in the art (cross-linking agents may be known as hardening agents).

In one embodiment, the cladding composition may include a light absorbing material. Light absorbing materials are described below in more detail.

At this point, those skilled in the art will appreciate that any known or available cladding material or combinations of cladding materials that may include an adhesive may be used to form the cladding layers 18A, 18B without departing from the scope of the present disclosure.

### The Light Absorbing Layer

The light absorbing composition includes a light absorbing material and an adhesive polymer. The light absorbing composition forms a light absorbing layer as part of the various waveguide embodiments described above and shown in FIGS. 1-8. The light absorbing material may be any suitable light absorbing material, such as carbon black, a dark material, a dark pigment, or a dark-colored dye. Dark includes black, grey, or any other color that is capable of absorbing ambient or other light entering the waveguide at greater than the acceptance angle. Light entering the waveguide or panel at greater than the acceptance angle needs to be absorbed so it does not travel through the waveguide it entered in to an adjacent waveguide, otherwise it results in a loss of image resolution. The light absorbing material may be a powder or a liquid dispersion wherein particles to be dispersed are about 0.05 μm to about 20 μm. In one embodiment the particles are about 0.05 μm to about 7 μm. In another embodiment the particles are about 0.05 μm to about 1 μm. Carbon black may be obtained from Cabot Corporation, Dick Blick Art Materials, Penn Color, Inc., Solution Dispersions, Inc., Wolstenholme International Ltd., or Color Mate, Inc. In one embodiment, the light absorbing composition may include carbon black and a binder, like an acrylic polymer, to disperse the carbon particles.

The adhesive included in the light absorbing composition may include any of the adhesives or combinations of the adhesives listed above for inclusion in the cladding layer. The adhesive is present in the light absorbing material to increase the mechanical strength of the waveguide and the panel formed from a plurality of waveguides. In one embodiment, the adhesive is also present in a high enough amount for the light absorbing layer to adhere the stacked waveguides together. In one embodiment, the adhesive included in the light absorbing composition may be the same adhesive used in the cladding layer and/or the adhesive layer. In one embodiment, the ratio of adhesive to light absorbing material may be about 1:1 to about 40:1 respectively. In another embodiment, the ratio of adhesive to light absorbing material may be about 4:1 to about 10:1. In another embodiment, enough light absorbing material may be added to result in an optical density of about 1.0-7.0 D. The optical density may be measured with an X-Rite 310 photographic densitometer where the visual density measurement is taken in transmission mode.

The light absorbing material may have a percent transmission of about 30 percent or less. In general, a lower percent transmission may be desired. Opaque materials with no transmission are totally absorbing and, therefore, more efficient than those that have a higher percent transmission. Opaque materials with a percent transmission greater than 30 percent will provide some degree of absorbency, but may be less efficient. In another aspect, the opaque material may have a percent transmission of from about 7% to about 1×10⁻⁵% transmission. In another aspect, the opaque material may have a percent transmission of from about 3% to about 1×10⁻⁵% transmission.

In one embodiment, the light absorbing composition may further include a polyethylene oxide to aide in the separation of layers in the simultaneous coating of multiple layers on the core. In one embodiment, the polyethylene oxide is 7% solid polyethylene oxide. The polyethylene oxide may be about 40 to about 60% solid in combination with any other polymers in the layer.

In another embodiment, the light absorbing composition may include water and/or any of the surfactants or other additives listed above for the cladding. The light absorbing layer may be applied to any other cladding layer or the core by any of the methods known in the art, as explained above.

At this point, those skilled in the art will appreciate that the light absorbing composition 19 should be selected to form a light absorbing layer within a waveguide that will effectively absorb light that is not totally internally reflected and will result in the waveguide having high mechanical strength.

### The Adhesive Layer

In one embodiment, an adhesive composition may be positioned between stacked waveguides to adhere or bond the plurality of waveguides into a panel. In another embodiment, the adhesive may be applied to at least one of the light absorbing layers. The adhesive composition may include any of the adhesives or combination of the adhesives listed above for inclusion in the cladding composition and/or the light absorbing composition. In another embodiment, the adhesive composition may include a thermosetting resin as disclosed in commonly assigned patent application Ser. No. 11,759,462 titled THERMOSETTING OPTICAL WAVEGUIDE COATING (attorney docket 070281-00007) filed on the same day as the current application.

In one embodiment, the thermosetting resin may be an epoxy resin selected from the group consisting of a bisphenol epoxy, urethane modified epoxy, a rubber modified epoxy and mixtures thereof. In another embodiment, the thermosetting resin may be an aqueous dispersion. Examples of thermosetting epoxy resins useful in adhesive layer 20 are available from Resolution Performance Products, such as EPR-REZ™ resin 5520—a urethane-modified epoxy resin, EPR-REZ™ resin 3522—a solid Bisphenol A epoxy resin, EPR-REZ™ resin 3540—a solid Bisphenol A epoxy resin with an organic co-solvent, or EPR-REZ™ resin 3519—a butadiene-acrylonitrile modified epoxy.

In another embodiment, the adhesive composition may include a light absorbing material. Light absorbing material may be any suitable light absorbing material, such as carbon black, a pigment, or a dye. Those skilled in the art will appreciate that light absorbing material absorbs ambient room light and provides improved viewability of the image when used in panels like those shown in FIGS. 4 and 9. Additionally, the dark material may help the adhesive layer absorb light and may prevent light entering above a critical angle from transmitting into another portion of the optical structure.

At this point, those skilled in the art will appreciate that the adhesive composition should be selected to form an adhesive that adheres to the material or materials selected for the light absorbing layers of a plurality of stacked waveguides to form a panel with high mechanical strength.

### Coating Compositions

In one embodiment, the waveguide includes a polycarbonate core having a first surface and a second surface. The polycarbonate may be a film available from GE. A cladding composition may be applied to both the first surface and the second surface of the core to form cladding layers. The cladding composition may include a urethane polyester based adhesive and a cladding material. The cladding composition may be about 30% solid adhesive to about 70% solid cladding material to about 70% solid adhesive to about 30% solid cladding material. The cladding material may be butadiene, like polystyrene butadiene. The cladding composition may further include a surfactant and water to form a liquid that can be used in the manufacturing process. A light absorbing composition may be applied to the cladding layers formed on the first and second surface of the polycarbonate core. The light absorbing composition may include a light absorbing material and a urethane polyester based adhesive. The light absorbing composition may contain about 30% solid adhesive to about 70% light absorbing material to about 99% solid adhesive to about 1% light absorbing material. The light absorbing material may be a carbon black dispersion. The urethane polyester based adhesive may be an aqueous dispersion of a polyurethane polyester adhesive. The light absorbing composition may further include a surfactant and water to form a liquid that can be used in the manufacturing process.

In another embodiment, the waveguide includes a PMMA core having a first surface and a second surface. A cladding composition may be applied to both the first surface and the second surface of the core to form cladding layers. The cladding composition may include an acrylic based cladding material, such as vinyl acrylic or carboxylated acrylic copolymer. The cladding composition may further include a surfactant and water to form a liquid that can be used in the manufacturing process. A light absorbing composition may be applied to the cladding layers formed on the first and second surface of the PMMA core. The light absorbing composition may include a light absorbing material and a urethane polyester based adhesive. The light absorbing composition may be about 30% solid adhesive to about 70% light absorbing material to about 99% solid adhesive to about 1% light absorbing material. The light absorbing material may be a carbon black dispersion. The urethane polyester based adhesive may be an aqueous dispersion of a polyurethane polyester adhesive. The light absorbing composition may further include a surfactant and water to form a liquid that can be used in the manufacturing process.

The optical core, cladding material, and thermosetting adhesive may be any of the substances disclosed herein. The waveguides may be formed using any of the methods disclosed herein or known in the art. In one embodiment, waveguides may be formed as sheets that are cut into smaller strips and the strips are stacked to form the panel. Uniform pressure may be applied to the stacked waveguides, followed by a curing period to allow the adhesives within the layers, especially the adhesive layer, to cure. The resulting panel may be cut into a desired shape and size and may be frosted or polished.

### EXAMPLES

### Example 1

A waveguide was made with the core and compositions for the cladding and light absorbing layers as shown in Table 1.

TABLE 1

| | Approximate | | | | |
|---|---|---|---|---|---|
| | Thickness | | | % | Parts |
| Layer | of Layer | Composition | Material | solids | (wet) |
| CORE | 240 μm | | polycarbonate, 10 mil | | |
| CLADDING | 7 μm | cladding | polystyrene butadiene | 50 | 104 |
| | | material | (Rovene 4170) | | |
| | | adhesive | polyurethane, aliphatic, | 40 | 110 |
| | | | polyester | | |
| | | | (Dispercoll U53) | | |
| | | other | fluoro-surfactant | ND | 3.3 |
| | | other | water | 0 | 58.7 |
| LIGHT | 6 μm | light absorbing | carbon black dispersion | 48 | 13.5 |
| ABSORBING | | material | (Colorsperse I-283) | | |
| | | adhesive | polyurethane, aliphatic, | 40 | 189 |
| | | | polyester, (Dispercoll U53) | | |
| | | other | surfactant | ND | 3.5 |
| | | other | water | 0 | 71.1 |

The core was provided as a 10 mil sheet for the above example, but sheets of other thickness may be used. The solutions for the cladding layer in Example 1 were mixed at 75° F. with a standard overhead agitator paddle blade for at least twenty minutes. The solutions for the light absorbing layer in Example 1 were mixed at 75° F. with a standard overhead agitator paddle blade for at least twenty minutes in a separate container. Both solutions were then sonicated for three minutes prior to coating and any visible foam at the top of the solution was removed by suction.

For the coating, a multilayer slide coating die was employed. Immediately after coating, the resulting coat was allowed to sit at room conditions for 260 seconds. Thereafter, the coating was successively dried under a 95° F. air flow and 20% relative humidity, and was then subjected to moisture content control to restore the layers to room conditions under an atmosphere of 75° F., and 40% relative humidity.

While the coatings in Example 1 were dried at fixed temperatures and humidities, it will be understood that on a commercial production basis, other drying methods may be preferred. Dryers having successive zones in which temperature and humidity can be closely controlled are in common use in the art of coating and may be employed for these examples.

### Example 2

A waveguide was made with the core and compositions for the cladding and light absorbing layers as shown in Table 2.

TABLE 2

| | Approximate | | | | |
|---|---|---|---|---|---|
| | Thickness of | | | % | Parts |
| Layer | Layer | Composition | Material | solids | (wet) |
| CORE | 240 μm | | polycarbonate, 10 mil | | |
| CLADDING | 7 μm | cladding | polystyrene butadiene | 50 | 121.3 |
| | | material | (Rovene 4170) | | |
| | | adhesive | polyurethane, aliphatic, | 50 | 87.8 |
| | | | polyester | | |
| | | | (Dispercoll U54) | | |
| | | other | fluoro-surfactant | ND | 2.9 |
| | | other | water | 0 | 88.7 |
| LIGHT | 6 μm | light absorbing | carbon black dispersion | 48 | 43.6 |
| ABSORBING | | material | (Colorsperse I-283) | | |
| | | adhesive | polyurethane, aliphatic, | 40 | 137.3 |
| | | | polyester, (Dispercoll U54) | | |
| | | other | surfactant | ND | 4.6 |
| | | other | water | 0 | 116.9 |

The core was provided as a 10 mil sheet for the above example, but sheets of other thickness may be used. The layers in Example 2 were mixed and coated according to the same procedure as Example 1.

### Example 3

A waveguide was made with the core and compositions for the cladding and light absorbing layers as shown in Table 3.

TABLE 3

| | Approximate | | | | |
|---|---|---|---|---|---|
| | Thickness of | | | % | Parts |
| Layer | Layer | Composition | Material | solids | (wet) |
| CORE | 240 μm | | polycarbonate, 10 mil | | |
| CLADDING | 7 μm | cladding | polystyrene butadiene | 50 | 121.5 |
| | | material | (Rovene 4170) | | |
| | | adhesive | polyurethane, aliphatic, | 40 | 110 |
| | | | polyester | | |
| | | | (Dispercoll U53) | | |
| | | other | fluoro-surfactant | ND | 3.3 |
| | | other | water | 0 | 66.5 |
| LIGHT | 6 μm | light absorbing | carbon black dispersion | 48 | 43.4 |
| ABSORBING | | material | (Colorsperse I-283) | | |
| | | adhesive | polyurethane, aliphatic, | 40 | 171 |
| | | | polyester, (Dispercoll U53) | | |
| | | other | surfactant | ND | 3.9 |
| | | other | water | 0 | 82.2 |

The core was provided as a 10 mil sheet for the above example, but sheets of other thickness may be used. The layers in Example 3 were mixed and coated according to the same procedure as Example 1.

### Example 4

A waveguide was made with the core and compositions for the cladding and light absorbing layers as shown in Table 4.

TABLE 4

| | Approximate | | | | |
|---|---|---|---|---|---|
| | Thickness of | | | % | Parts |
| Layer | Layer | Composition | Material | solids | (wet) |
| CORE | 240 μm | | polycarbonate, 10 mil | | |
| CLADDING | 7 μm | cladding | polystyrene butadiene | 50 | 101.9 |
| | | material | (Rovene 4170) | | |
| | | adhesive | waterborne urethane | 40 | 96.1 |
| | | | (Helmibond 882) | | |
| | | other | fluoro-surfactant | ND | 3 |
| | | other | water | 0 | 348.9 |
| LIGHT | 6 μm | light absorbing | carbon black dispersion | 48 | 22 |
| ABSORBING | | material | (Colorsperse I-283) | | |
| | | adhesive | waterborne urethane | 40 | 192.5 |
| | | | (Helmibond 882) | | |
| | | other | surfactant | ND | 3.5 |
| | | other | water | 0 | 176 |

The core was provided as a 10 mil sheet for the above example, but sheets of other thickness may be used. The layers in Example 4 were mixed and coated according to the same procedure as Example 1.

### Example 5

A waveguide was made with the core and compositions for the cladding and light absorbing layers as shown in Table 5.

TABLE 5

| | Approximate | | | | |
|---|---|---|---|---|---|
| | Thickness | | | % | Parts |
| Layer | of Layer | Composition | Material | solids | (wet) |
| CORE | 240 μm | | PMMA, 10 mil | | |
| CLADDING | 6 μm | cladding | vinyl acrylic | 53.5 | 200 |
| | | material/adhesive | (CR41) | | |
| | | other | fluoro-surfactant | ND | 3.1 |
| LIGHT | 6 μm | light absorbing | carbon black dispersion | 53 | 29.7 |
| ABSORBING | | material | (T2K63F) | | |
| | | adhesive | polyurethane polyester | 50 | 74.4 |
| | | | (Simalfa R52) | | |
| | | other | polyethylene oxide | 7 | 44.6 |
| | | other | fluoro-surfactant | ND | 6.9 |
| | | other | water | 0 | 64.4 |

The core was provided as a 10 mil sheet for the above example, but sheets of other thickness may be used. The cladding and the light absorbing compositions were mixed separately at room temperature and pressure. Each layer was simultaneously coated onto the core using a multilayer slide coating process. The light absorbing layer was coated to be thicker than the cladding layer. The layers dried remained separated upon drying.

### Example 6

A waveguide was made with the core and compositions for the cladding and light absorbing layers as shown in Table 6.

TABLE 6

| | Approximate | | | | | |
|---|---|---|---|---|---|---|
| | Thickness | | | | % | Parts |
| Layer | of Layer | | Composition | Material | solids | (wet) |
| CORE | 240 | μm | | PMMA, 10 mil | | |
| CLADDING | 4 | μm | cladding | carboxylated acrylic | 48 | 135.3 |
| | | | material/adhesive | copolymer (Glascol RP3) | | |
| | | | cladding material | carboxylated acrylic | 48 | 45.1 |
| | | | | copolymer (Glascol RP4) | | |
| | | | other | fluoro-surfactant | ND | 1.2 |
| | | | other | Water | 0 | 318.3 |
| LIGHT | 3.5 | μm | light absorbing | carbon black dispersion | 53 | 130 |
| ABSORBING | | | material | (T2K63F) | | |
| | | | adhesive | polyurethane polyester | 50 | 14.4 |
| | | | | (Simalfa R52) | | |
| | | | other | fluoro-surfactant | ND | 2.3 |
| | | | other | water | 0 | 303.3 |
| ADHESIVE | 10 | μm | adhesive | polyurethane polyester | 50 | 206.5 |
| | | | | (Simalfa R52) | | |
| | | | light absorbing | carbon black dispersion | 53 | 35 |
| | | | material | (T2K63F) | | |
| | | | other | fluoro-surfactant | | 8.8 |
| | | | other | water | | 81.3 |

The core was provided as a 10 mil sheet for the above example, but sheets of other thickness may be used.

Although various aspects of the disclosed optical waveguide coatings and associated structures and methods have been shown and described, modifications may occur to those skilled in the art upon reading the specification. The present application includes such modifications and is limited only by the scope of the claims; and therefore, is to be understood that the present invention is not limited to the particular embodiments disclosed above, but it is intended to cover such modifications and variations as defined by the following claims.

What is claimed:

1. A method for making a waveguide comprising:
providing an optical core having a first surface and a second surface;
applying a cladding material to the first and the second surface of the optical core to form a first cladding layer on the first surface of the optical core and a second cladding layer on the second surface of the optical core; and
applying a light absorbing composition including a light absorbing material and a first adhesive polymer on at least one of the first cladding layer and the second cladding layer to form a light absorbing layer;
wherein the first adhesive polymer is selected from the group consisting of urethane, epoxy, polyester, acrylic adhesives and mixtures thereof.

2. The method of claim 1 wherein the first adhesive polymer becomes adhesive at about 50 to about 95° C.

3. The method of claim 2 wherein the first adhesive polymer is a urethane polyester.

4. The method of claim 3 wherein the first adhesive polymer is a polyurethane polyester.

5. The method of claim 1 wherein the light absorbing material is selected from the group consisting of a carbon black material, a pigment, a dye, and mixtures thereof.

6. The method of claim 1 wherein the optical core includes at least one of glass, a polycarbonate, a polymethylmethacrylate, a polycyclic olefin, a polyester, a cellulose, and copolymers thereof.

7. The method of claim 1 wherein the cladding material is a polymer or polymer mixture of a urethane, a butadiene, an acrylic, an epoxy, or an acrylate.

8. The method of claim 1 wherein the cladding material includes a second adhesive polymer.

9. The method of claim 8 wherein the second adhesive polymer is selected from the group consisting of urethane, epoxy, polyester, acrylic adhesives and mixtures thereof.

10. The method of claim 8 wherein the second adhesive polymer and the first adhesive polymer are the same.

11. The method of claim 7 wherein the polymer or polymer mixture includes a polyethylene oxide.

12. The method of claim 11 wherein the optical core is polymethylmethacrylate.

13. The method of claim 7 wherein the cladding material is the acrylic polymer or polymer mixture and the light absorbing composition further includes a polyethylene oxide.

14. The method of claim 13 wherein the acrylic is a carboxylated acrylic copolymer and the optical core is a polymethylmethacrylate.

15. The method of claim 7 wherein the butadiene polymer or polymer mixture includes a styrene butadiene.

16. The method of claim 15 wherein the optical core is a polycarbonate.

17. The method of claim 1 wherein the steps of applying the cladding material and the light absorbing material are carried out simultaneously.

18. The method of claim 1 further comprising the step of positioning an adhesive composition on at least the first light absorbing layer.

19. The method of claim 18 wherein the adhesive composition includes a third adhesive polymer.

20. The method of claim 19 wherein the third adhesive polymer is the same as the first adhesive polymer or the second adhesive polymer.

21. The method of claim 18 wherein the adhesive composition includes a light absorbing material.

22. The method of claim 1 wherein the first light absorbing layer and the second light absorbing layer each have a thickness of about 1 to about 11 μm.

23. The method of claim 1 wherein the first cladding layer and the second cladding layer each have a thickness of about 1 to about 11 μm.

24. A method for making a waveguide comprising:
providing an optical core having a first surface and a second surface;
applying a cladding material including a first adhesive polymer to the first and the second surface of the optical core to form a first cladding layer on the first surface of the optical core and a second cladding layer on the second surface of the optical core; and
applying a light absorbing composition including a light absorbing material and a second adhesive polymer to at least one of the first cladding layer and the second cladding layer to form a light absorbing layer;
wherein the first adhesive polymer and the second adhesive polymer are selected from the group consisting of urethane, epoxy, polyester, acrylic adhesives and mixtures thereof.

25. The method of claim 24 wherein the urethane-based adhesive is an aqueous dispersion.

26. The method of claim 24 wherein the urethane-based adhesive includes a polyester based structure.

27. The method of claim 26 wherein the adhesive is a polyurethane polyester dispersion.

28. The method of claim 24 wherein the light absorbing material is selected from the group consisting of a carbon black material, a pigment, a dye, and mixtures thereof.

29. The method of claim 24 wherein the first adhesive polymer and the second adhesive polymer are the same.

30. The method of claim 24 wherein the optical core includes at least one of glass, a polycarbonate, a polymethylmethacrylate, a polycyclic olefin, a polyester, a cellulose, and copolymers thereof.

31. The method of claim 24 wherein the cladding material is a polymer or polymer mixture of a urethane, a butadiene, an acrylic, an epoxy, or an acrylate.

32. The method of claim 31 wherein the polymer or polymer mixture includes a polyethylene oxide.

33. The method of claim 32 wherein the optical core is polymethylmethacrylate.

34. The method of claim 31 wherein the acrylic is a carboxylated acrylic copolymer and the optical core is a polymethylmethacrylate.

35. The method of claim 31 wherein the butadiene polymer or polymer mixture is a styrene butadiene and the optical core is a polycarbonate.

36. The method of claim 24 further comprising the step of positioning an adhesive composition including a third adhesive polymer on at least the first light absorbing layer.

37. The method of claim 36 wherein the third adhesive polymer is selected from the group consisting of a rubber, a urethane, a cellulose derivative, a polyester, a polyacrylate, an epoxy, a silicone, a formaldehyde resin, a phenolic resin, a vinyl polymer, a polyether, a furane, a polyaromatic, and mixtures thereof.

38. The method of claim 36 wherein the third adhesive polymer is the same as the first adhesive polymer or the second adhesive polymer.

39. The method of claim 37 wherein the third adhesive polymer is a polyurethane polyester.

40. The method of claim 36 wherein the third adhesive polymer is a thermosetting resin.

41. The method of claim 40 wherein the thermosetting resin is selected from the group consisting of a biphenol epoxy, an urethane modified epoxy, a rubber modified epoxy, and mixtures thereof.

42. The method of claim 36 wherein the adhesive composition includes a light absorbing material.

43. The method of claim 24 wherein the first light absorbing layer and the second light absorbing layer each have a thickness of about 1 to about 11 μm.

44. The method of claim 24 wherein the first cladding layer and the second cladding layer each have a thickness of about 1 to about 11 μm.
